(19) United States
(12) Patent Application Publication
(10) Pub. No.: US 2004/0018294 A1
(43) Pub. Date: Jan. 29, 2004

(54) PRODUCTION OF HIGH PROTEIN CONCENTRATES

(75) Inventor: PEGGY M. TOMASULA, TITUSVILLE, NJ (US)

Correspondence Address: USDA-ARS-OFFICE OF TECHNOLOGY TRANSFER, NATIONAL CTR FOR AGRICULTURAL UTILIZATION RESEARCH, 1815 N. UNIVERSITY STREET, PEORIA, IL, 61604, US

(73) Assignee: PEGGY M. TOMASULA

(21) Appl. No.: 09/247,219

(22) Filed: Feb. 10, 1999

(51) Int. Cl. A23L 1/025

(52) U.S. Cl. 426/656; 426/802; 426/513; 426/511

(57) ABSTRACT

Processes for concentrating protein, especially digestible protein from plants, and particularly the concentration of protein from non-animal sources without contaminating the protein with ingredients used in a purification process.

### BACKGROUND

1. Field of the Invention

The present invention relates to processes for concentrating protein, especially digestible protein from plants. The invention particularly relates to the concentration of protein from non-animal sources without contaminating the protein with ingredients used in a purification process.

2. Background of the Art

The use of food products derived from soy has been increasing significantly for the past twenty years. Many “imitation” foods such as artificial bacon, seafood, milks, beverages, and extenders use soy protein products, and the ability of processors to provide soy protein with improved taste, and the ability of food product companies to manufacture more realistic food products from soy have increased their palatability and commercial acceptability. These manufacturing features, in combination with health efforts to reduce the cholesterol in diets has led to an increased demand for soy protein, particularly in the form of soy protein concentrates or soy protein isolates. There is also an increased desire to find other non-animal sources of protein concentrates, such as from other grains, including, but not limited to corn, rye, wheat, and the like.

The term concentrate is generally considered in the art to include any product which contains higher concentrations of protein than the original source material. The actual percentages will vary, depending upon the source of the protein. Soy has one of the higher levels of native protein concentration, with certain genetic strains approaching fifty percent (50%) or higher. The term isolate, such as a soy protein isolate, usually refers to a concentrate with at least about 90% by total weight (e.g., 90-96% by weight) of solids as protein. Most grain or vegetable sources (hereinafter collectively referred to as vegetable protein, even if the non-animal source is not strictly a vegetable) have to be significantly treated to provide an isolate or a concentrate with more than 60% by weight of total solids as protein.

Conventional concentrating processes depend upon direct chemical treatment of the source vegetable matter to concentrate the protein. For example, raw soy products such as soy meal, soy flakes, and soy flour are treated with acid (e.g., hydrochloric acid) to precipitate protein and separate the protein from whey, sugars, oils and proteins which will not precipitate. Some of the acid remains in the protein precipitate and must be removed by additional processing either specific or generic to removal of the acid residue. As the acid is undesirable from many standpoints of flavor, aesthetics and health, it is important that substantially all of the acid is removed. The processing necessary to do this may be sufficiently harsh as to reduce the value and content of the soy protein concentrate or soy protein isolate produced by the acid treatment process.

There are also many physical processes for producing protein-rich products from grains. U.S. Pat. No. 5,135,765, for example, describes a process for producing a protein-rich product from brewer's spent grain containing germ, husks and a proteinaceous material. The process requires the use of high water content spent grain (e.g., at least about 65% water by weight), passing the wet spent grain through a mill to press and grind the solids, and then sieving the spent grain in water to produce an at least 50% by weight protein product. After formation of the first concentrate, the coarse fraction may be extracted with alkaline aqueous solution at elevated temperature to form an extract, and the extract is acidified to form a further concentrated protein rich precipitate.

It is well known that soy bean products may have undesirable taste components. These components are known to be reduced or removed by selection of unique varieties of soy beans for the original source, heating an intermediate soy bean product to reduce lipoxygenase, extraction with an aqueous solution, extraction with an alkali solution, extraction with a reducing agent (e.g., see U.S. Pat. No. 5,023,104), extraction with organic solvents (e.g., removal of chlorohydrins from hydrolyzed protein compositions in U.S. Statutory Registration No. H989) and extraction with high pressure or supercritical carbon dioxide (e.g., “Preparation and Evaluation of Supercritical Carbon Dioxide Defatted Soybean Flakes” A. C. Eldridge, et al., Journal of Food Science, Vol.51, No.3, 1986, pp.584-587; “Off-Flavor Removal from Soy-Protein Isolate by Using Liquid and Supercritical Carbon Dioxide”JAOCS, Vol. 72, no. 10, 1995, pp. 1107-1115; “Emulsifying Properties of Low-fat, Low-cholesterol Egg Yolk Prepared by Supercritical CO₂ Extraction”Journal of Food Science, Vol. 61, No. 1, 1996, pp. 19-23 and 43; and U.S. Pat. No. 4,493,854 shows extraction of oil from soy (e.g., flakes) by CO₂ extraction, leaving extracted meal as a by-product. The purpose of the process is to improve the flavor of the soy products by removal of undesirable flavor materials in the soy product. The process in U.S. Pat. No. 4,493,854 produces an enhanced flavor oil by tempering the initial soy material with moisture and extracting oil from the tempered soy product, but the by-product of protein and other solids is not a significantly concentrated product and is not an isolate, as it would still contain the whey, sugars and other materials not extracted by the CO₂.

### BRIEF DESCRIPTION OF THE INVENTION

The ability to generate an isolate without the need of using acid to precipitate the protein provides a number of highly beneficial results to the practice of this technology. The use of CO₂ to lower the pH, as opposed to the application of an acid such as the typically used hydrochloric acid, avoids any need for subsequent purification of the isolate from materials added during the concentration of the protein. The acid must be carefully removed, usually by thorough wash steps. On the other hand, CO₂ or its carbonic acid product vaporize at even ambient temperature and are tasteless and harmless. This not only simplifies the process, but avoids the need for disposal of waste streams. The use of an acid requires disposal of the treating solution (acid solution) runoff as well as disposal of the wash solutions. These additional steps are more costly, time consuming and potentially polluting, especially as compared to the disposal of CO₂ or carbonic acid. It is also anticipated that the absence of the acid, even the trace amounts which might be present, would allow for an improved taste product.

The present invention may be generally practiced by a process which comprises providing a vegetable protein source (such as soy) material having a protein concentration of less than 80% by total weight of solids. This vegetable protein source is then concentrated to more than 90% by total weight (of all solids in the product) of protein by treating a solution/dispersion of the vegetable protein source by a series of process steps in a batch or continuous manner with the process at least comprising:

a) applying a pressure of from about 400 to 1200 or 400 to 800 pounds per square inch (psi) to the solution/dispersion (this pressure may be provided primarily or exclusively by adding a CO₂ rich or pure CO₂ stream into the chamber or vessel in the batch process, while in a continuous process it may be more convenient, but not required, to first apply pressure to the section of the system containing the solution and then subsequently add the CO₂);

b) providing or adding CO₂ at the elevated pressure to form carbonic acid (H₂CO₃) in the solution/dispersion;

c) heating the solution/dispersion, resulting in an increase in pressure;

d) adding additional CO₂ to reduce the pH of the solution/dispersion;

e) holding the pressurized and heated solution/dispersion;

f) depressurizing the solution/dispersion; and

g) removing precipitated protein.

### DETAILED DESCRIPTION OF THE INVENTION

The process of the invention may be practiced as a batch or continuous process. The batch process would be performed in a single tank or vessel having the pressure and control elements desirable for the practice of the process within the defined parameters. The practice of the process as a continuous process may be performed in apparatus such as that described in U.S. Pat. No. 5,432,265, which is incorporated herein by reference for the complete disclosure of the structure and method of operation of that apparatus. Other modifications on the structure of the apparatus for performing the process are within the design choice and the skill of the ordinary artisan.

A vegetable protein source (such as soy) material having a protein concentration of less than 80% by total weight of solids is concentrated to more than 90% by total weight of protein by treating a solution/dispersion of the vegetable protein source to a treatment at least comprising:

a) applying an atmospheric pressure of from about 400 to 800 pounds per square inch (psi) to the solution/dispersion;

b) providing or adding CO₂ at the elevated pressure to form carbonic acid (H₂CO₃) in the solution/dispersion;

c) heating the solution/dispersion, resulting in an increase in pressure;

d) adding additional CO₂ to reduce the pH of the solution/dispersion;

e) holding the pressurized and heated solution/dispersion;

f) depressurizing the solution/dispersion; and

g) removing precipitated protein.

The time, temperature, pressure and pH will vary among various protein source materials. For example, with soy source materials such as flake, flour or meal, a good range of useful parameters would be a pressure between 400 to 800 psi (preferably between about 500 and 700 psi), heating between about 35 to 90 degrees Centigrade (preferably between 40 and 75 degrees Centigrade), reducing the pH to less than 6.5 (preferably to less than 6, and more preferably to less than 5.5 or less than 5, such as to 4.2-4.9), and a holding time of from 5 minutes to two hours (preferably from about 10 minutes to one hour).

The vegetable protein source may be any vegetable protein material (e.g., flake, meal, flour or residue from other treatment processes) which has a protein content of less than 80% by total weight of solids, preferably less than 70% or less than 60%, and more preferably less than 50% or less than 40% by total weight of solids. Soy sources are generally preferred, but the process finds applicability, with variations within the general scope of parameters defined in the practice of the present invention, to any grains, flakes, flour, meal or the like which has significant protein content (e.g., at least 5% by total weight of solids, preferably at least 10% or at least 15 or 20% by weight of total solids as protein). Other sources such as corn, oats, wheat, barley, rice, alfalfa and the like containing various proportions of proteins called the albumins (which are water-soluble or water-dispersible), the prolamines (which are soluble in ethanol), the globulins (which are soluble in salt solutions), and the glutelins (which are soluble in alkali solutions) could also be used in the practice of the present invention.

The solutions/dispersion of the protein source are usually provided in the product in a dispersed format, such as at least a 2% by weight solution/dispersion in an aqueous carrier or plain water. (The term ‘solution’ will be used hereafter, even though the protein source is more accurately a combination of solution and dispersion (or even emulsion), with various components in different states within the carrier.) The solution of protein source is usually provided in sufficient concentration of the solid containing the protein source to warrant treatment and improve efficiencies of time and space. For that reason, rather than for any fundamental necessity in the chemistry or physics of the process, the weight content of the protein source (not the protein only) in the water would be at least about 4 or 5%, more likely from a commercial standpoint at least 7 or 8%, still more likely at least about 10%, at least about 15% and less than 40% by weight total solids in the solution. It is generally practiced that the solution have less than 25% by total weight of protein merely to maintain the viscosity of the solution/dispersion at an easily workable condition. The lower weights limits are selected to assure at least a minimum volume of output, and the higher limit is generally selected to assure that there is efficient precipitation of the protein. If the concentration were too high, there would be more difficulty in assuring that the carbonic acid would precipitate high levels of protein available. This higher concentration practice is still within the scope of the invention if the holding equipment were built with sufficient strength to withstand the higher pressure necessary to provide the CO₂ at these much higher pressures.

The initial pressure above the surface of the solution is usually provided as a pressure of from about 400 to 800 pounds per square inch (psi) to the solution/dispersion. The initial pressure in the vessel will usually be lower and the pressure may be increased at a desired rate. There is likely to be at least some CO₂ present in the gas over the surface of the solution in the vessel, but normal atmospheric CO₂ content would not be sufficient to effect the process of the present invention. The initial solution may also be pretreated to advance the process. For example, prior to the application of pressure in the vessel or even before introduction of the solution into the vessel, the solutions may be pretreated by heating the solution (e.g., from about 30 to 75 degrees Centigrade), adding NaOH to neutralize the solution (to a pH of about 7) with stirring. The mixture would then be filtered and centrifuged. The resulting supernatants would then be chilled before the CO₂ treatment. These are examples of advantageous but not essential types of pretreatment steps in the practice of the present invention. Sufficient CO₂ should be introduced into the system to lower the pH below 7, preferably below about 6 and more preferably below about 5.5. Heating is performed either before, during or after the addition of the CO₂ into the system, or at a combination of these times. The heating is generally effected to provide a solution temperature of between 30 and 75 degrees Centigrade for soy protein and may be varied as desired or applicable on an individual basis for the particular grains or protein source selected. This heating also increases the pressure within the reaction vessel or system and assists in keeping the CO₂ in the solution.

Additional CO₂ is added, reducing the pH of the solution further, often by at least 0.5 pH units. The CO₂ may be added to effect a supercritical state over the solution to assure the effectiveness and concentration levels of the carbonic acid in the solution. The final pH is generally below 5.5, more often below 5, as for example between 4 and 5 or between 4.2 and 4.8 (e.g., 4.5). The solution in the vessel or the solution within a continuous apparatus system is then held at these conditions for a time sufficient to assist in the precipitation of the protein. Some protein will begin to precipitate early in the holding period, but it is more efficient to hold the solution for a longer period of time such as at least 1, at least 3, or at least 5 minutes, at least 10 minutes or at least 20 or at least 30 minutes. If time is not a critical factor, there is no limit to the holding period, but 10 to 60 minutes is the expected range to be considered, balanced in part by the temperature and pressure conditions which influence the precipitation efficiency of the reaction.

The pressurized solution is then depressurized and the precipitate removed (e.g., by screening, filtering or any other available physical separation method). This process has produced isolates with a protein concentration of 94.2% in a batch process from soy flakes. The isolate was expected to have good flavor.

It is important to note that the present invention uses the carbonic acid in the solution to precipitate and thereby concentrate the protein from the solution. This is substantively different than the use of supercritical CO₂ to remove trace flavor materials as practiced in mere extraction processes such as those identified above. Extraction removes either desirable materials from a mass (so that the desirable materials, such as oils, may be collected) or removes minor amounts of undesirable materials from a mass (such as the removal of objectionable flavors from soy, as described above). There is no specific objective in concentrating the proteins in the solution from 5 to 30% by weight solids in the initial solution to more than 85%, more than 87% or more than 90% by total weight of solids in a final product. Extraction processes, in fact, are usually performed on concentrates and isolates and reference is seldom if ever made to any further concentration of the solids, even though some minor increase of the percentage of protein in the solid product is likely to occur. Additionally, these extraction processes often act to remove materials which are soluble in the CO₂ rather than act to precipitate materials by a process where after adding the flakes, meal or flour to water there is a dissolution of the albumins and glutelins into the water of the solution or dispersion. By bringing the pH to 7 or higher, through the addition of a base such as the NaOH (although this is not necessary for soy), there is probably higher dissolution of the glutelin into the aqueous portion of the solution. When working with corn, NaOH is sometimes added to loosen protein-protein matrices so that protein is released (e.g., “Corn-Chemistry and Technology” S. A. Watson and P. E. Ramstad, eds., American Association of Cereal Chemists, Inc. St. Paul, Min). Globulins would solubilize, probably because of the release of salts from the legume or grain into the dispersion. At this point, the dispersion may be centrifuged to remove the pellet containing fiber, some carbohydrates, and some fats (if the feed material wasn't defatted), unsolubilized protein, minerals, etc. The prolamine proteins, if any, remain in the pellet.

When CO₂ is added to the dispersion or to the supernatant (if the solution/dispersion was centrifuged), there is a drop in pH due to the formation of carbonic acid from the CO₂. The carbonic acid reacts with any base if present to form, for example, sodium carbonate and sodium bicarbonate salts, as well as salts from any minerals present in the dispersion/solution, thereby solubilizing additional globulins from the pellet. The drop in pH, along with the formation of salts causes a change in the solubility of the glutelins, globulins, and albumins, and they precipitate out of the solution/dispersion. However, upon release of pressure, the pH returns almost to the original value of the solution/dispersion before introduction of the CO₂, and indication that most of the CO₂ has evolved. Therefore there are no contaminating salts in the whey. In conventional precipitation with hydrochloric acid (Hcl), the hydrochloric acid would remain in the whey and the final pH would be about 4.4. The freshly precipitated soy protein isolate has a gel or curdlike appearance (possibly indicative of protein-protein interactions) in contrast to the hydrochloric acid treated material, which has a granular appearance.

With regard to copending, commonly assigned application processes such as the whey process described in U.S. patent application Ser. No. 08/996,136, whey proteins are comprised of alpha-lactalbumin (alpha-La, about 30%) and beta-lactalbumin (about 50%), the rest being irnmunoglobulins (Igs), Bovine serum albumin (BSA), and proteose-peptones. An enriched fraction of alpha-La containing the alpha-La, Igs, BSA and proteose-peptones were isolated. The mechanism appears to be a combination of pH, heat, and possibly salt formation. The pH is initially lowered with CO₂ and probably causes a release of calcium from the alpha-La and changes the conformation of the protein. The calcium probably exists in solution as a bicarbonate. Addition of heat above 50° C., along with the depressed pH causes the alpha-La to form aggregates. The alpha-La most likely entraps the Igs, BSA and maybe the proteose-peptones. The aggregates get big enough and drop out of the whey solution/dispersion as a precipitate, with the breakdown of the linkages causing the casein to precipitate. In this case the heat does not seem to foster aggregation, but changes the mechanical strength of the protein.

In U.S. Pat. No. 5,432,265, the casein precipitation process was used with CO₂ to demonstrate the fact that the process can operate under high pressure continuously. Although the present invention establishes that the apparatus described therein can be used for the present process, the chemistry of the soy process and other isolate manufacturing processes is completely different, as are the operating conditions. In a CO₂-soy protein isolate process, there is no need for NaOH pretreatment. The feed piston pump used to feed the milk process would be replaced, for example, by a progressing cavity pump or a screw feeder. If there were a pretreatment with NaOH, that extraction stage would be followed by centrifuging, and then a piston feed pump, such as that used with the milk process, could be used. Different residence times would also require changes in the size of the reactor and flow rates which could not be established except by operation of the novel soy-protein process. The mechanism of the removal/concentration of proteins in U.S. Pat. No. 5,432,265 is also substantially different from that occurring in the present invention, so it would not have been obvious to attempt to use the system of that patent to effect the process of the present invention with an expectation that a substantively different process mechanism with substantially different results would occur. In the process of U.S. Pat. No. 5,432,265, the component being removed is casein, a protein product comprising proteins linked by calcium phosphate bonds. One of the first steps in the process of U.S. Pat. No. 5,432,265 is to break these bonds so that individual proteins are held in solution/dispension. That process then adjusts the temperature of the solution/dispersion, causing the proteins to agglomerate, entrapping other solids and dissolved materials within the network of agglomerated proteins. This process is specifically temperature dependent and the proteins precipitate as agglomerated materials. In the present invention, there is no dissolving of calcium phosphate bonds to free proteins, there is no agglomeration of proteins, proteins precipitate by more traditional physical phenomena where the change in pH of the solution/dispersion causes decreased solubility of selected proteins, and those specific proteins (which fortuitously happen to be the desirable proteins) precipitate from the solution/dispersion, leaving other dissolved and carried materials within the solution/dispersion. The fundamental nature of the precipitation process of the present invention for proteins is different and unexpected from the agglomeration process which occurs in the casein removal process of U.S. Pat. No. 5,432,265.

With regard to the general extraction process patents described above, these mechanisms rely upon the differences in density between the oils and CO₂. At supercritical pressures of around 10,000 psi, CO₂ has a density and other properties that mimic those of a liquid solvent. At supercritical pressures of around 10,000 psi, CO₂ has a density that mimics a liquid solvent. The supercritical CO₂ also exhibits transport properties, such as viscosity and diffusivity, that mimic a gas. In operation, the practitioners typically pack a very small column with soy flakes (or other material), pressurize with CO₂, circulate the CO₂ through the column for a couple of hours to dissolve oil and establish equilibrium, and then crack open a valve to a flask. The rapid decrease in pressure causes the CO₂ to gasify and the oil previously carried by the CO₂ to precipitate into the flask. The flakes don't move continuously through the process, whereas in the present invention, where a continuous process would be performed, all solids and liquids would move. More importantly, in the extraction process, only the oil and essentially hydrocarbon soluble materials are absorbed into the supercritical gas stream, but there is no precipitation of protein from a solution/dispersion.

### EXAMPLE

A 10% dispersion of soy flakes in water was prepared by placing 100 grams of flakes into 1000 grams of water. The flakes were Specialty 90 flakes from Cargill Protein Products Department (analysis 56% protein; 7% moisture; 1% fat; 3.2% fiber; and 6.3% ash). NaOH was added to bring the solution to pH 7.0, the solution heated to 55° C. and stirred for 30 minutes. This was then followed by centrifuging. The pellet was discarded and 750 grams of the supernatant was used to fill a Parr high pressure batch reactor. The supernatant was chilled to 6OC to increase the solubility of CO₂ when added to the high pressure reactor vessel. The lid to the reactor was secured and CO₂ was allowed to fill the reactor until a pressure of 600 psi was indicated on a Bourdon type gauge. The pH of the solution was measured at this pressure with a high pressure pH probe and was measured at about 5.8. The contents of the reactor were then heated to 50° C. by heating through the jacket of the reactor. Additional CO₂ was added until the pressure of the reactor was about 1040 psi. The pH of the mixture was about 4.5. Carbon dioxide was supplied from a cylinder equipped with a dip tube. Cylinder pressure was about 850 psi. The pressure was boosted to about 1040 psi using a Haskell pump. After approximately 25 minutes, the liquid was removed from a valve depressurizing the reactor. The lid was opened and the protein was scraped out of the reactor. The liquid was centrifuged to remove any solids, and these scraped solids were added to the other solids removed from the reactor. The mixture from the reactor had a solids content of 38% by weight. Analytical results showed that the product contained 95% protein and 0.9% fat. The solid material did not have to be further purified.

What is claimed:

1. A process for providing a concentrate of vegetable protein comprising:
a) applying a pressure of from about 400 to 800 pounds per square inch (psi) to an initial solution/dispersion of vegetable protein and associated vegetable solids;
b) providing or adding CO₂ at the elevated pressure to form carbonic acid (H₂CO₃) in the solution/dispersion;
c) heating the solution/dispersion, resulting in an increase in pressure;
d) adding additional CO₂ to the solution dispersion to reduce the pH of the solution/dispersion;
e) holding the pressurized and heated solution/dispersion;
f) depressurizing the solution/dispersion; and
g) removing solid precipitate which has a higher concentration of protein than the initial solution/dispersion.

2. The process of claim 1 wherein said initial solution dispersion comprises a solution or dispersion of soy solids.

3. The process of claim 2 wherein said soy solids comprise a material selected from the group consisting of meal, flour and flake.

4. The process of claim 1 wherein said vegetable protein and associated vegetable solids is neutralized before step a).

5. The process of claim 1 wherein the concentration of protein in the solid precipitate of step g) has a protein concentration of at least 90% by total weight of solids.

6. The process of claim 2 wherein the concentration of protein in the solid precipitate of step g) has a protein concentration of at least 90% by total weight of solids.

7. The process of claim 3 wherein the concentration of protein in the solid precipitate of step g) has a protein concentration of at least 90% by total weight of solids.

8. The process of claim 1 wherein the protein is soy protein and the concentration of soy protein in the solid precipitate of step g) has a protein concentration of at least 90% by total weight of solids.

9. The process of claim 2 wherein the pH in step d) is reduced to between 4.2 and 4.8.

10. The process of claim 7 wherein the pH in step d) is reduced to between 4.2 and 4.8.

11. The process of claim 2 wherein holding time in step e) is for between 10 and 60 minutes.

12. The process of claim 11 wherein the holding time is at a temperature between 30 and 75 degrees Centigrade and a pressure between 400 and 1200 psi.

13. The process of claim 2 wherein the pH in step d) is reduced to between 4.2 and 5.0.

14. The process of claim 7 wherein the pH in step d) is reduced to between 4.2 and 5.0.
